(19) United States
(12) Patent Application Publication
(10) Pub. No.: US 2026/0095066 A1
(43) Pub. Date: Apr. 2, 2026

(54) Three-Dimensional Isotropic Power Reception System and Method thereof

(71) Applicant: The United States of America, as Represented by the Secretary of the Navy, Arlington, VA (US)

(72) Inventor: David Alan Garren, Clifton, VA (US)

(21) Appl. No.: 19/055,843

(22) Filed: Feb. 18, 2025

Related U.S. Application Data
(63) Continuation-in-part of application No. 18/903,117, filed on Oct. 1, 2024.

(51) Int. Cl. H02J 50/20; H01Q 1/24

(52) U.S. Cl. CPC H02J 50/20; H01Q 1/241

(57) ABSTRACT

A system for isotropically receiving radio frequency (RF) energy, the system comprising: a transmitter comprising a transmit structure configured to radiate an omnidirectional RF power pattern; a receiver configured to receive linearly polarized RF energy, the receiver further comprising a receiver antenna at a location r={r, θ, Φ}, wherein r is a line of site distance from the transmitter to the receiver, θ is a polar angle, and Φ is an azimuthal; and wherein the receiver antenna is oriented towards the transmitter at all locations r.

### CROSS-REFERENCE TO RELATED APPLICATIONS

This patent application is a Continuation in Part of U.S. patent application Ser. No. 18/903,117, titled Omnidirectional Conformal Antenna Power Pattern and Method thereof filed on Oct. 1, 2024, now U.S. Pat. No.______, the contents of which are expressly incorporated herein by this reference as though set forth in their entirety and to which priority is claimed. Patent

### STATEMENT OF GOVERNMENT INTEREST

The present disclosure was made in the performance of official duties by one or more employees of the Department of the Navy, and thus, embodiments herein may be manufactured, used or licensed by or for the Government of the United States of America for governmental purposes without the payment of any royalties thereon or therefor.

### FIELD OF USE

The present disclosure relates, in general, to a system and method of isotropically receiving radio frequency energy. More specifically, the present disclosure relates to a system and method of receiving an isotropic omnidirectional conformal antenna power.

### BACKGROUND

Generally, antennas convert radio frequency energy between guided electromagnetic energy and radiated electromagnetic energy or vice versa. The guided portion is typically constrained to a transmission line and described electromagnetically, while the antenna's radiation pattern describes the radiated portion. The antenna pattern is a graphical representation of how the antenna radiates electromagnetic energy.

An ideal antenna is typically studied and described as an isotropic radiator, a hypothetical lossless antenna that radiates its energy equally in all directions. This imaginary antenna would have a spherical radiation pattern, and the principal plane cuts would be circles.

Unlike traditional antenna radiation patterns, the Omnidirectional Conformal Antenna Power Pattern and method thereof, as described in U.S. patent application Ser. No. 18/903,117, does not comprise nodal lines, nodal planes, and lobes, such as a main lobe, a side lobe, or a back lobe. Generally, a nodal line or plane is an interference feature that may be observed in an antenna radiation pattern. A lobe is any part of the pattern that is surrounded by regions of relatively weaker radiation. The areas of weaker radiation may contain information that is lost or unusable.

An omnidirectional conformal antenna power pattern generally comprises a uniform radiation pattern. Still, a receiver may not necessarily detect a true isotropic radiation pattern or equal power at all angular elevations. The omnidirectional conformal antenna's actual radiated power has an angular dependence that scales as the sum of unity and the square of the cosine of the spherical polar angle. This means that a receiver configured to receive both circularly polarized and linearly polarized signals will receive an omnidirectional conformal antenna radiated power pattern that scales monotonically from a minimum on the equator of the spherical coordinates to a maximum at the poles, corresponding to twice the minimum power.

The problem with an omnidirectional conformal antenna power pattern system, as described in U.S. patent application Ser. No. 18/903,117, is that the received radiated power has an angular dependence.

Therefore, what is needed is a system or method of receiving an omnidirectional conformal antenna power pattern that is also independent of angular orientation relative to an omnidirectional conformal antenna transmitting system.

The background section is provided to reveal information believed by the applicant to be of possible relevance to the present technology. No admission is necessarily intended, nor should be construed, that any of the preceding information constitutes prior art against the present technology.

### SUMMARY

To minimize the limitations in the prior art, and to minimize other limitations that will become apparent upon reading and understanding the present specification, the present disclosure discloses a new and useful system and method of receiving an isotropic omnidirectional conformal antenna power.

The following presents a simplified overview of the example embodiments in order to provide a basic understanding of some embodiments of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The problem with an omnidirectional conformal antenna power pattern having a received power angular dependency is solved by using a receiver configured to receive linearly polarized electromagnetic energy and a transmitting system configured to radiate a 3D omnidirectional antenna power pattern.

Receiving a constant electromagnetic power independent of a spherical polar angle may reduce the complexity of a receiving system by not requiring gain control of received electromagnetic energy. By exciting an antenna with an electric current density that rotates azimuthally on the surface of a contour or spherical structure, an antenna may radiate an omnidirectional and near-uniform radiation pattern without nodal lines or nodal planes. A receiving system may isotropically receive electromagnetic energy from an omnidirectional radiation pattern by orientating a linearly polarized antenna and receiving system toward a transmit system independent of a spherical polar angle.

One embodiment of a system for isotropically receiving radio frequency (RF) energy, the system comprising: a transmitter comprising a transmit structure configured to radiate an omnidirectional RF power pattern; a receiver configured to receive linearly polarized RF energy, the receiver further comprising a receiver antenna at a location r={r, θ, Φ}, wherein r is a line of site distance from the transmitter to the receiver, θ is a polar angle, and Φ is an azimuthal; and wherein the receiver antenna is oriented towards the transmitter at all locations r. Wherein the transmit structure may be configured with inputs electrically coupled to a distribution, the distribution distributing a first current described by K_{θ}(r, t)=\tilde{K}₀ cos(ωt±Φ), and a second current described by K_{Φ}(r, t)=±\tilde{K}₀ cos(θ) sin(ωt±Φ), wherein K_{θ}(r, t) and K_{Φ}(r, t) may be the electric current density on a surface of the transmit structure as a function of a position vector (r) and time (t), ω is the angular frequency of rotation, θ is a polar angle, and Φ is an azimuthal. Wherein an electric current density K(r, t)=K_{θ}(r, t)\hat{θ}(θ, Φ)+K_{Φ}(r, t)\hat{Φ}(Φ) rotates azimuthally on a surface of the transmit structure, wherein at any fixed spatial location r on the surface of the transmit structure, the orthogonal \hat{θ}(θ, Φ) and \hat{Φ}(Φ) components of K(r, t) may be π/2 radians out of phase, wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal. Wherein the electric current density may be a θ-dependent elliptical polarization over the surface of the transmit structure. Wherein the electric current density may be a degenerate circular polarization at poles θ={0, π}. Wherein the electric current density may be linearly polarized at

$$θ = \frac{π}{2} .$$

Wherein the transmit structure has a radius a, and the receiver antenna may be placed at the location r>a. Wherein the system for isotropically receiving RF energy may further be configured to be frequency independent. Wherein a radiation pattern may be proportional to 1+cosine²(θ).

In an alternate embodiment an isotropic radio frequency (RF) communication system comprising: a communications transmitter comprising a transmit structure configured to radiate an omnidirectional RF power pattern; a communications receiver configured to receive linearly polarized RF energy, and the communications receiver further comprising a receiver antenna at a location r={r, θ, Φ}; and wherein the receiver antenna may be oriented towards the communications transmitter at all locations r. Wherein the transmit structure may be configured with inputs electrically coupled to a distribution, the distribution distributing a first current described by K_{θ}(r, t)=\tilde{K}₀ cos(ωt±Φ), and a second current described by K_{Φ}(r, t)=±\tilde{K}₀ cos(θ) sin(ωt±Φ), wherein K_{θ}(r, t) and K_{Φ}(r, t) may be the electric current density on a surface of the transmit structure as a function of a position vector (r) and time (t), ω is the angular frequency of rotation, θ is a polar angle, and Φ is an azimuthal. Wherein an electric current density K_{θ}(r, t)=K_{Φ}(r, t)\hat{θ}(θ, Φ)+K_{Φ}(r, t)\hat{Φ}(Φ) rotates azimuthally on a surface of the transmit structure, wherein at any fixed spatial location r on the surface of the transmit structure, the orthogonal \hat{θ}(θ, Φ) and \hat{Φ}(Φ) components of K(r, t) may be π/2 radians out of phase, wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal. Wherein the electric current density may be a θ-dependent elliptical polarization over the surface of the transmit structure. Wherein the electric current density may be a degenerate circular polarization at poles θ={0, π}. Wherein the electric current density may be linearly polarized at

$$θ = \frac{π}{2} .$$

Wherein the transmit structure has a radius a, and the receiver antenna may be placed at a location r>a. Wherein a radiation pattern may be proportional to 1+cosine²(θ).

In an alternative embodiment may be a method of receiving radio frequency (RF) energy isotropically comprising: providing a radio frequency transmitter configured to radiate an omnidirectional RF power pattern; providing an RF receiver configured to receive linearly polarized RF energy, the RF receiver further comprising a receiver antenna at a location r={r, θ, Φ}, wherein the receiver antenna may be oriented towards the RF transmitter at all locations r; providing electric current densities; distributing, by a distribution network, the electric current densities to feed each of the antennas a first current density and a second current density, wherein a first current may be K_{θ}(r, t)=\tilde{K}₀ cos(wt±Φ) and a second current may be K_{Φ}(r, t)=±\tilde{K}₀ cos(θ) sin(ωt±Φ), and wherein the electric current density rotate azimuthally around a surface of a contoured volume or a surface, wherein at any fixed spatial location r on the surface of the sphere, the orthogonal \hat{θ}(θ, Φ) and \hat{Φ}(Φ) components of K_{(r,t)} may be π/2 radians out of phase, wherein K_{θ}(r, t) and K_{Φ}(r, t) may be the electric current density on a surface of the transmit structure as a function of a position vector (r) and time (t), ω is the angular frequency of rotation, θ is a polar angle, and Φ is an azimuthal; and radiating, by the antenna array, a cumulative power pattern proportional to 1+cosine²(θ). Providing multiple current densities of different frequency. Encoding, by spread spectrum encoding, a stream of data across multiple different frequencies of the electric current densities.

It is an object to overcome the limitations of the prior art.

These, as well as other components, steps, features, objects, benefits, and advantages, will now become clear from a review of the following detailed description of illustrative embodiments, the accompanying drawings, and the claims.

### BRIEF DESCRIPTION OF THE DRAWINGS

The drawings are of illustrative embodiments. They do not illustrate all embodiments. Other embodiments may be used in addition or instead. Details which may be apparent or unnecessary may be omitted to save space or for more effective illustration. Some embodiments may be practiced with additional components or steps and/or without all of the components or steps which are illustrated. When the same numeral appears in different drawings, it refers to the same or like components or steps.

FIG. 1 is one embodiment of a system for isotropically receiving radio frequency energy.

FIG. 2 is another embodiment of a system for isotropically receiving radio frequency energy.

FIG. 3 is another embodiment of a system for isotropically receiving radio frequency energy.

FIG. 4A is a normalized power graph showing power versus spherical polar angle.

FIG. 4B is a normalized power graph in dB showing power versus spherical polar angle.

FIG. 5 is a flow block diagram of one method of receiving omnidirectional radio frequency power.

### DETAILED DESCRIPTION OF THE ILLUSTRATIVE EMBODIMENTS

In the following detailed description of various embodiments of the present disclosure, numerous specific details are set forth in order to provide a thorough understanding of various aspects of one or more embodiments of the present disclosure. However, one or more embodiments of the present disclosure may be practiced without some or all of these specific details. In other instances, well-known methods, procedures, and/or components have not been described in detail so as not to unnecessarily obscure aspects of embodiments of the present disclosure.

While multiple embodiments are disclosed, still other embodiments of the devices, systems, and methods of the present disclosure will become apparent to those skilled in the art from the following detailed description, which shows and describes illustrative embodiments of the devices, systems, and methods of the present disclosure. As will be realized, the devices, systems, and methods of the present disclosure are capable of modifications in various obvious aspects, all without departing from the spirit and scope of the present disclosure. Accordingly, the screenshot figures, and the detailed descriptions thereof, are to be regarded as illustrative in nature and not restrictive. Also, the reference or non-reference to a particular embodiment of the devices, systems, and methods of the present disclosure shall not be interpreted to limit the scope of the present disclosure.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

The present methods and systems may be understood more readily by reference to the following detailed description of preferred embodiments and the examples included therein and to the Figures and their previous and following description.

In the following description, certain terminology is used to describe certain features of one or more embodiments. For purposes of the specification, unless otherwise specified, the term “substantially” refers to the complete or nearly complete extent or degree of an action, characteristic, property, state, structure, item, or result. For example, in one embodiment, an object that is “substantially” located within a housing would mean that the object is either completely within a housing or nearly completely within a housing. The exact allowable degree of deviation from absolute completeness may in some cases depend on the specific context. However, generally speaking, the nearness of completion will be so as to have the same overall result as if absolute and total completion were obtained. The use of “substantially” is also equally applicable when used in a negative connotation to refer to the complete or near complete lack of an action, characteristic, property, state, structure, item, or result.

As used herein, the terms “approximately” and “about” generally refer to a deviance of within 5% of the indicated number or range of numbers. In one embodiment, the term “approximately” and “about”, may refer to a deviance of between 0.001-10% from the indicated number or range of numbers.

Various embodiments are now described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

Furthermore, the one or more versions may be implemented as a method, apparatus, or article of manufacture using standard programming and/or engineering techniques to produce entirely hardware embodiment, an entirely software embodiment, or an embodiment combining software and hardware embodiments. Furthermore, the systems and methods may take the form of Non-transitory computer readable media. More particularly, the present methods and systems may take the form of web-implemented computer software or a computer program product. Any suitable computer-readable storage medium may be utilized including, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick).

Those skilled in the art will recognize many modifications may be made to this configuration without departing from the scope of the disclosed embodiments.

Embodiments of the systems and methods are described below with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that may direct a computer or other programmable data processing apparatus to function in a particular manner. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, may be implemented by special purpose hardware-based computer systems that perform the specified functions or steps, or combinations of special purpose hardware and computer instructions.

In the following description, certain terminology is used to describe certain features of the various embodiments of the device, method, and/or system. For example, as used herein, the terms “computer” and “computer system” generally refer to any device that processes information with an integrated circuit chip and/or central processing unit (CPU).

As used herein, the terms “software” and “application” refer to any set of machine-readable instructions on a machine, web interface, and/or computer system” that directs a computer's processor to perform specific steps, processes, or operations disclosed herein.

As used herein, the term “computer-readable medium” refers to any storage medium adapted to store data and/or instructions that are executable by a processor of a computer system. The computer-readable storage medium may be a computer-readable non-transitory storage medium and/or any non-transitory data storage circuitry (e.g., buggers, cache, and queues) within transceivers of transitory signals. The computer-readable storage medium may also be any tangible computer readable medium. In various embodiments, a computer readable storage medium may also be able to store data, which is able to be accessed by the processor of the computer system.

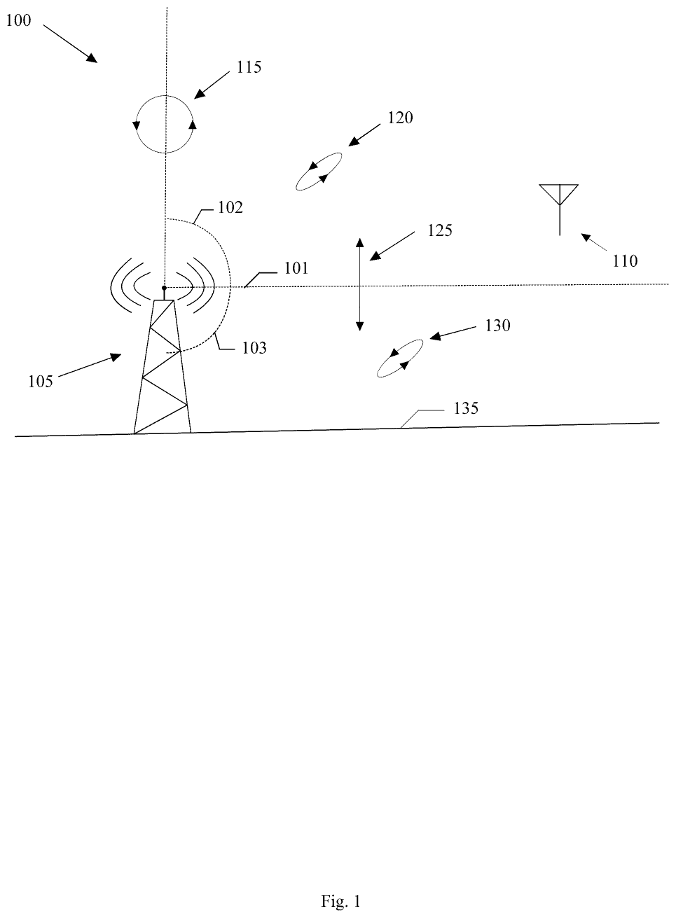

FIG. 1 is one embodiment of a system for isotropically receiving radio frequency energy. Transmit system 100 may preferably have an electric current density flowing azimuthally on the surface of a spherical shell, wherein the magnitude of the electric current density scales as the sine of the spherical polar angle may yield closed-form expressions for the resulting electromagnetic (EM) fields without invoking any approximations involving the relative sizes of the radio frequency (RF) wavelengths, the sphere radius, or the distance to an observation point. Such an electric current density may have a related profile that rotates azimuthally on the surface of a sphere, generating a fully 3-dimensional (3D) omnidirectional power pattern that may not exhibit nodal lines and nodal planes. Additionally, the power pattern for the subject rotating sphere antenna concept may be invariant to all RF frequencies. A relationship between Cartesian unit vectors {\hat{x}, ŷ, \hat{z}} and spherical unit vector {\hat{r}(θ, Φ), \hat{θ}(θ, Φ), \hat{Φ}(Φ)} may be determined to be:

$$\hat{r} ( θ , Φ ) = sin ( θ ) cos ( Φ ) \hat{x} + sin ( θ ) sin ( Φ ) \hat{y} + cos ( θ ) \hat{z} ,$$

$$\hat{θ} ( θ , Φ ) = cos ( θ ) cos ( Φ ) \hat{x} + cos ( θ ) sin ( Φ ) \hat{y} - sin ( θ ) \hat{z} ,$$

$$\hat{Φ} ( Φ ) = - sin ( Φ ) \hat{x} + cos ( Φ ) \hat{y} .$$

The Cartesian unit and spherical unit vector relationship may be used to calculate the electromagnetic (EM) fields for the following time-dependent electric current density K_{θ}(r, t) and K_{Φ}(r, t) that rotates azimuthally on the surface of a sphere of radius r=a:

$${K}_{θ} ( r , t ) = {\tilde{K}}_{0} cos ( ω t \pm Φ ) ,$$

$${K}_{Φ} ( r , t ) = \pm {\tilde{K}}_{0} cos ( θ ) sin ( ω t \pm Φ ) .$$

In terms of magnitude \hat{K} and the angular frequency ω, the upper and lower signs correspond with azimuthal rotation in the +\hat{Φ}(Φ) and −\hat{Φ}(Φ) directions, respectively. At any given fixed spatial location r on the surface of the sphere, the orthogonal \hat{θ}(θ, Φ) and \hat{Φ}(Φ) components of K(r, t) are π/2 radians out of phase. Thus, this surface electric current density corresponds to a θ-dependent elliptical polarization over the surface of the sphere, with the degenerate cases of circular polarization at the poles of θ={0, π} and linear polarization at the equator of θ=π/2.

Transmit system 105 may have angular regions above equator 102, angular regions below equator 103, and equator regions 101. Angular regions above equator 102, angular regions below equator 103, and equator region 101 may express different polarizations of the electric current density. The electric current density may be circularly polarized at or near region 115, which may appear at or near 90 degrees above or below equator region 101, and at different φ 120 and 130 toward equator region 101, the polarization of the electric current density may become more elliptical, and at or near 0 near equator region 125, the polarization may become linear. At distances further away from transmit system 105 along surface 135, the electric current density may appear more linear than distances closer to transmit system 105, which may appear more circularly polarized.

Receiver system 110 may be a linearly polarized receiver system. Suppose receiver system 110 is in a global spherical coordinates r={r, θ, Φ} system such that the center of the transmission system 105 transmission antenna is located at the origin and its axis of rotation corresponds with the z-axis. Receiver system 110 may include one or more linearly polarized receiver antennas such that each of the receiver antennas may be configured, located, and oriented independently. Receiver system 110 may be located and oriented based on knowledge of the location and orientation of the spherical shell transmission antenna. Receiver system 110 antenna may be placed at an arbitrary location r={r, θ, Φ} outside the radius of the spherical transmission antenna. Additionally, there may be no restrictions that a receiver system 110 antenna must be placed only in the far-field region because near-field locations may also be permitted.

Assuming receiver system 110 has knowledge of both the location and the orientation of the transmission antenna may enable receiver system 110 antenna to apply the spherical unit vectors {\hat{r}(θ, Φ), \hat{θ}(θ, φ), \hat{φ}(φ)} for the spherical shell transmission antenna. Orient the linearly polarized antenna direction of receiver system 110 such that it lies entirely along the local value of the spherical polar unit vector \hat{θ}(θ, Φ), which may vary with the spherical polar angle θ and the spherical azimuthal angle φ. “Local” refers to the act of relocating the receiver antenna from one location r₁={r₁, θ₁, φ₁} to another location r₂={r₂, θ₂, φ₂}, and the linear polarization direction may change from \hat{θ}(θ₁, φ₁) to be \hat{θ}(θ₂, φ₂). The E-field \hat{θ}(θ, Φ)-component of the E-field of a spherical transmit antenna may have the same functional form to within an irrelevant phase constant, regardless of the selected spherical angles θ and φ. That is, for an assumed receiver antenna location at r₁={r₁, θ₁, φ₁}, the \hat{θ}(θ, Φ)-component of the E-field may be:

$${E}_{θ} ( r , t ) = \hat{{E}_{0}} \frac{1}{k {r}_{1}} \{ 1 + \frac{1}{i k {r}_{1}} {e}^{i \{ ω t - k {r}_{1} ∓ {ϕ}_{1} \}}$$

The E-field varies harmonically according to exp(iωt) with a magnitude of:

$$\hat{{E}_{0}} \frac{1}{k {r}_{1}} \sqrt{1 + \frac{1}{{k}^{2} {r}_{1}^{2}}}$$

to within an irrelevant phase constant of exp(−i[kr₁±φ₁]), which may not affect the overall transfer of radiative power from the transmission system 105 antenna to the receiver system 110 antenna. The \hat{φ}(θ, φ)-component of the E-field is unimportant in this context since the linearly polarized receiver antenna may be oriented to receive only the EM signal components that may be oriented in the local \hat{θ}(θ, φ) direction. Receiver system 110 antenna may now be relocated to a new position r₂={r₁, θ₂, φ₂} having the same spherical radius r=r₁ as the first location but different values for the spherical polar angles that now may be given by θ=θ₂ and φ=φ₂. Modifying the polarization of receiver system 110 antenna so that it is oriented with the new orientation of the spherical polar angle, which is now given by \hat{θ}(θ₂, φ₂). For this second location and orientation, the signal received may be determined by the E-field that again varies harmonically according to exp(iωt) with a magnitude to within a different irrelevant phase constant of exp(−i[kr₁±φ₂]). Such that the receiver system 110 power collected by the linearly polarized receiver antenna is unaffected by the spherical angles θ and φ, provided that the spherical radial distance r remains unchanged but the linear polarization direction is adjusted so that it always lies along the direction of the local spherical polar unit vector \hat{θ}(θ, Φ).

An alternative embodiment may be a radio frequency communication system that includes a communications transmitter system and a communications receiver system. The communication transmitter system may encode a carrier signal with a data signal with an electric current density flowing azimuthally on the surface of a spherical shell, wherein the magnitude of the electric current density scales as the sine of the spherical polar angle may yield closed-form expressions for the resulting electromagnetic (EM) fields without invoking any approximations involving the relative sizes of the radio frequency (RF) wavelengths, the sphere radius, or the distance to an observation point. A communications receiver system may decode a carrier signal to recover a data signal.

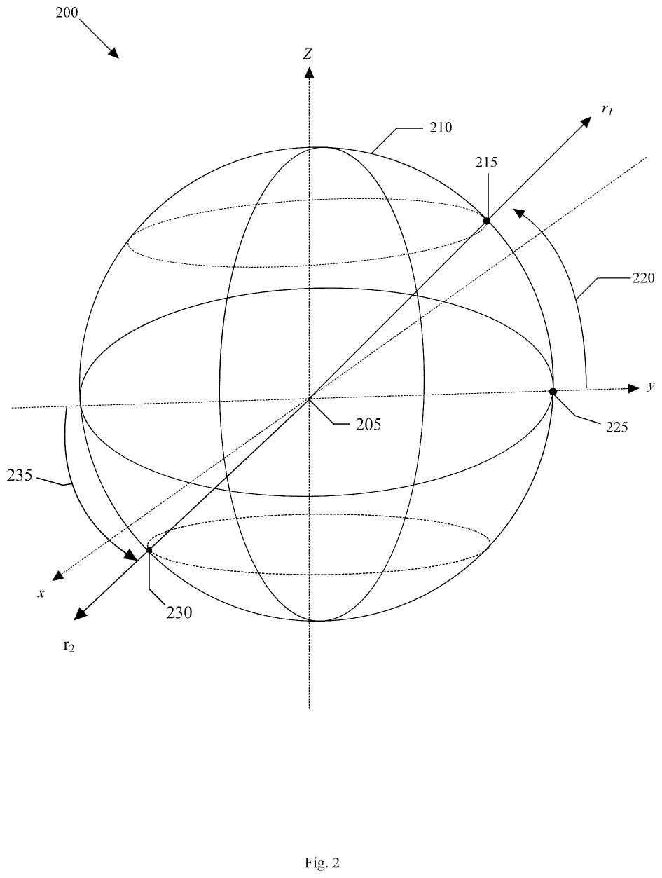

FIG. 2 is another embodiment of a system for isotropically receiving radio frequency energy. Isotropic receiving system 200 may include transmit system 205 and receiving systems 215 and 230 in a free space volume 210. Receiving systems 215, 225, and 230 may be similarly oriented and at separate polar angles 220 and 230 but receive substantially the same electromagnetic energy because r1 and r2 may be equal distances from transmit system 205. Utilizing knowledge of transmits system 205 orientation receiving system 215, 225, and 230 may maintain distance r and orientation towards transmit system 205 to maintain a constant received energy.

In one embodiment, receiving systems 215, 225, and 230, having knowledge of transmit system 205, may vary θ about transmit system 205, while not limited to maintaining orientation towards transmit system 205, polar angle 220 and 230, and maintaining a distance r, may receive an equal electromagnetic energy.

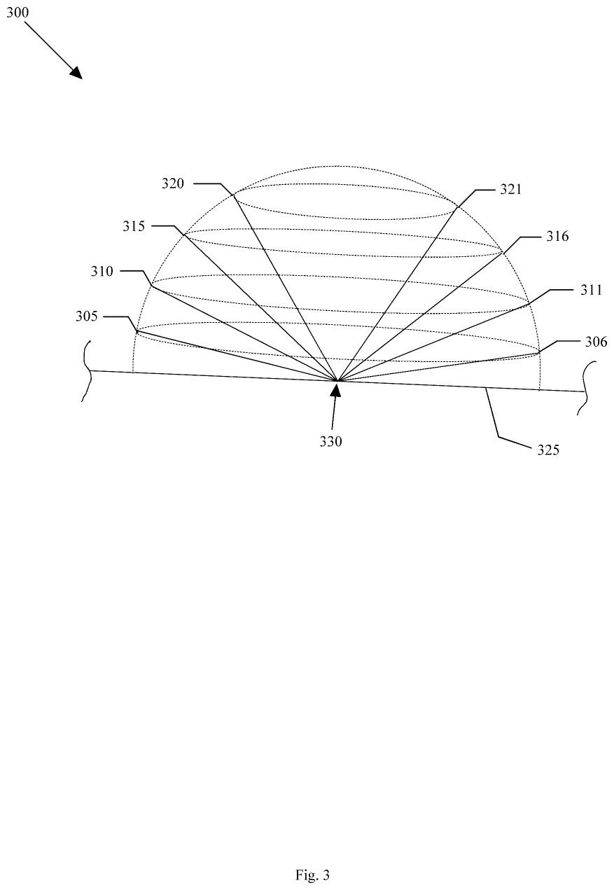

FIG. 3 is another embodiment of a system for isotropically receiving radio frequency energy. Isotropic receiving system 300 may include multiple receiving systems 305, 306, 310, 311, 315, 316, 320, and 321. Receiving systems 305, 306, 310, 311, 315, 316, 320, and 321 may all have different angles relative to surface 325, but all may have linear antennas similarly oriented towards transmit system 330 and receive relatively similar electromagnetic energy.

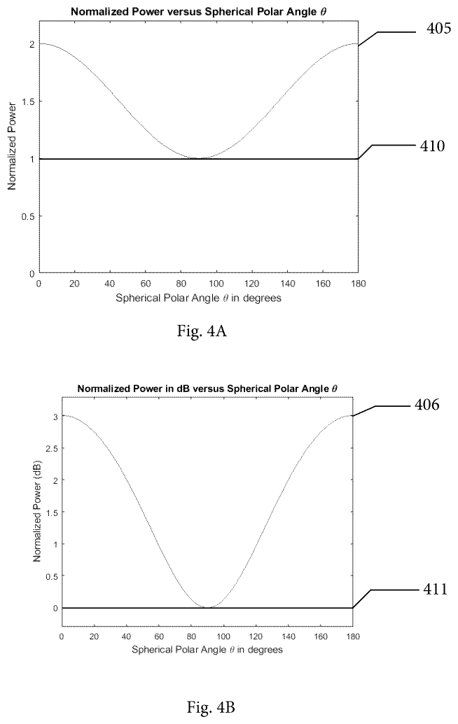

FIG. 4A is a normalized power graph showing power versus spherical polar angle. As shown in FIG. 4A, the normalized power received by a circularly polarized antenna and receiving system 405 varies by spherical polar angle, while a linearly polarized antenna and receiving system 410 receives a constant independent of spherical polar angle.

In an alternate embodiment, a circularly polarized antenna and receiving system may be used at spherical polar angles and distances to vary usable distance at specific frequencies.

FIG. 4B is a normalized power graph in dB showing power versus spherical polar angle. As shown in FIG. 4B, the normalized power received in dB by a circularly polarized antenna and receiving system 405 varies by spherical polar angle, while a linearly polarized antenna and receiving system 410 receives a constant power in dB independent of spherical polar angle.

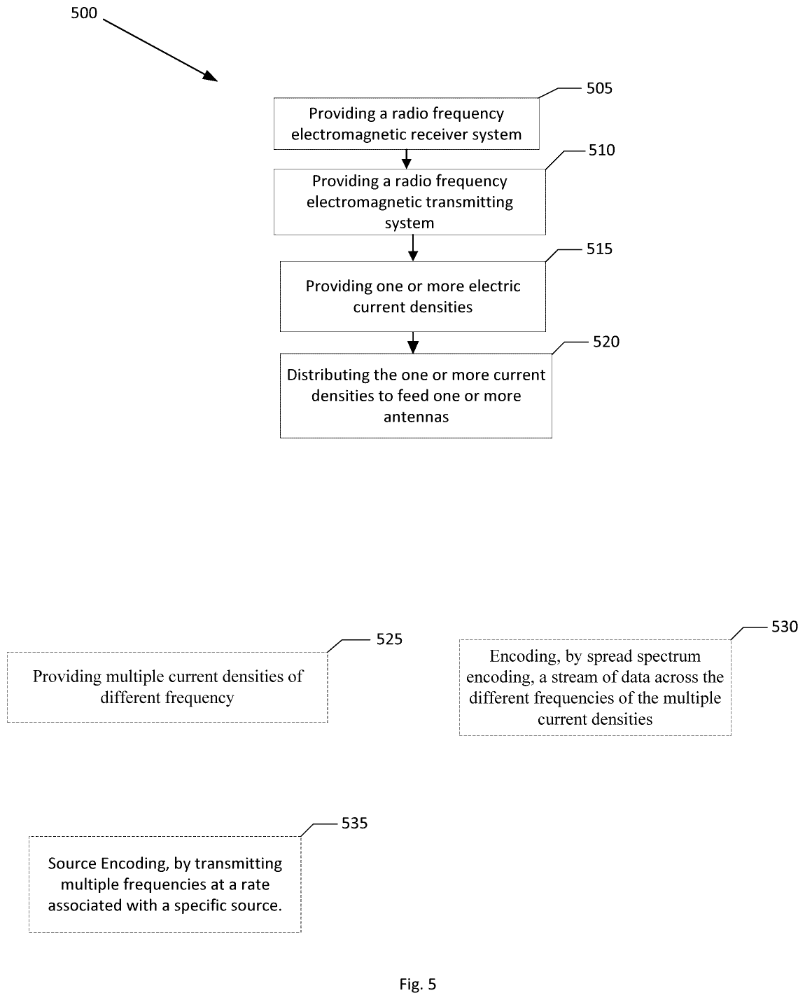

FIG. 5 is a flow block diagram of one method of receiving omnidirectional radio frequency power. A method of receiving radio frequency energy isotropically comprising: 500 providing a radio frequency receiver system 505 configured to receive linearly polarized electromagnetic energy, the receiver system further comprising a receiver antenna at a location r={r, θ, Φ}, wherein the receiver antenna is preferably oriented towards the transmit system at all locations r; providing a radio frequency transmit system 510 configured to radiate an omnidirectional power pattern; providing one or more electric current densities 515; distributing 520, by a distribution network, the one or more electric current densities to feed each of the one or more antennas a first current density and a second current density, wherein the first current is K_{θ}(r, t)=\tilde{K}₀ cos(ωt±Φ) and the second current is K_{Φ}(r, t)=±\tilde{K}₀ cos(θ) sin(ωt±Φ), and wherein the electric current density rotates azimuthally around a surface of the contoured volume or surface, wherein at any fixed spatial location r on the surface of the sphere, the orthogonal \hat{θ}(θ, Φ) and \hat{Φ}(Φ) components of K_{(r,t)} are π/2 radians out of phase; and radiating, by the antenna array, a cumulative power pattern proportional to 1+cosine²(θ).

In alternate embodiment providing multiple current densities 525 of different in frequency.

In alternative embodiment encoding 530, by spread spectrum encoding, a stream of data across the different frequencies of the multiple current densities.

In alternative embodiment source encoding 535, transmitting multiple frequencies at a rate associated with a specific source.

Unless otherwise stated, all measurements, values, ratings, positions, magnitudes, sizes, locations, and other specifications that are set forth in this specification, including in the claims that follow, are approximate, not exact. They are intended to have a reasonable range that is consistent with the functions to which they relate and with what is customary in the art to which they pertain.

Some portions of the preceding detailed descriptions have been presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it should be appreciated that throughout the present disclosure, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system's memories or registers or other such information storage, transmission or display devices.

The processes or methods depicted in the figures may be performed by processing logic that comprises hardware (e.g., circuitry, dedicated logic, etc.), firmware, software (e.g., embodied on a non-transitory computer readable medium), or a combination thereof. Although the processes or methods are described above in terms of some sequential operations, it should be appreciated that some of the operations described may be performed in a different order. Moreover, some operations may be performed in parallel rather than sequentially.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but are not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

The foregoing description of the preferred embodiment has been presented for the purposes of illustration and description. While multiple embodiments are disclosed, still other embodiments will become apparent to those skilled in the art from the above detailed description. These embodiments are capable of modifications in various obvious aspects, all without departing from the spirit and scope of protection. Accordingly, the detailed description is to be regarded as illustrative in nature and not restrictive. Also, although not explicitly recited, one or more embodiments may be practiced in combination or conjunction with one another. Furthermore, the reference or non-reference to a particular embodiment shall not be interpreted to limit the scope of protection. It is intended that the scope of protection not be limited by this detailed description, but by the claims and the equivalents to the claims that are appended hereto.

Except as stated immediately above, nothing that has been stated or illustrated is intended or should be interpreted to cause a dedication of any component, step, feature, object, benefit, advantage, or equivalent, to the public, regardless of whether it is or is not recited in the claims.

What is claimed is:

1. A system for isotropically receiving radio frequency (RF) energy, the system comprising:
a transmitter comprising a transmit structure configured to radiate an omnidirectional RF power pattern;
a receiver configured to receive linearly polarized RF energy, the receiver further comprising a receiver antenna at a location r={r, θ, Φ}, wherein r is a line of site distance from the transmitter to the receiver, θ is a polar angle, and Φ is an azimuthal; and wherein the receiver antenna is oriented towards the transmitter at all locations r.

2. The system of claim 1, wherein the transmit structure is configured with one or more inputs electrically coupled to a distribution, the distribution distributing a first current described by K_{θ}(r, t)=\tilde{K}₀ cos(ωt±Φ), and a second current described by K_{Φ}(r, t)=±\tilde{K}₀ cos(θ) sin(ωt±Φ), wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal.

3. The system of claim 2, wherein an electric current density K(r, t)=K_{θ}(r, t)\hat{θ}(θ, Φ)+K_{Φ}(r, t)\hat{Φ}(Φ) rotates azimuthally on a surface of the transmit structure, wherein at any fixed spatial location r on the surface of the transmit structure, the orthogonal \hat{θ}(θ, Φ) and \hat{Φ}(Φ) components of K(r, t) are radians out of phase, wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal.

4. The system of claim 3, wherein the electric current density is a θ-dependent elliptical polarization over the surface of the transmit structure.

5. The system of claim 3, wherein the electric current density is a degenerate circular polarization at poles θ={0, π}.

6. The system of claim 3, wherein the electric current density is linearly polarized at
$$θ = \frac{π}{2} .$$

7. The system of claim 1, wherein the transmit structure has a radius a, and the receiver antenna is placed at the location r>a.

8. The system of claim 1, further configured to be frequency independent.

9. The system of claim 1, wherein a radiation pattern is proportional to 1+cosine²(θ).

10. An isotropic radio frequency (RF) communication system comprising:
a communications transmitter comprising a transmit structure configured to radiate an omnidirectional RF power pattern;
a communications receiver configured to receive linearly polarized RF energy, and the communications receiver further comprising a receiver antenna at a location r={r, θ, Φ}; and
wherein the receiver antenna is oriented towards the communications transmitter at all locations r.

11. The system of claim 10, wherein the transmit structure is configured with one or more inputs electrically coupled to a distribution, the distribution distributing a first current described by K_{θ}(r, t)=\tilde{K}₀ cos(t±+Φ), and a second current described by K_{Φ}(r, t)=±\tilde{K}₀ cos(θ) sin(ωt±Φ), wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal.

12. The system of claim 11, wherein an electric current density K(r, t)=K_{θ}(r, t)\hat{θ}(θ, Φ)+K_{Φ}(r, t)\hat{Φ}(Φ) rotates azimuthally on a surface of the transmit structure, wherein at any fixed spatial location r on the surface of the transmit structure, the orthogonal \hat{θ}(θ, Φ) and \hat{Φ}(Φ) components of K(r, t) are π/2 radians out of phase, wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal.

13. The system of claim 12, wherein the electric current density is a θ-dependent elliptical polarization over the surface of the transmit structure.

14. The system of claim 12, wherein the electric current density is a degenerate circular polarization at poles θ={0, π}.

15. The system of claim 12, wherein the electric current density is linearly polarized at
$$θ = \frac{π}{2} .$$

16. The system of claim 10, wherein the transmit structure has a radius a, and the receiver antenna is placed at a location r>a.

17. The system of claim 10, wherein a radiation pattern is proportional to 1+cosine²(θ).

18. A method of receiving radio frequency (RF) energy isotropically comprising:
providing a radio frequency transmitter configured to radiate an omnidirectional RF power pattern;
providing an RF receiver configured to receive linearly polarized RF energy, the RF receiver further comprising a receiver antenna at a location r={r, θ, Φ}, wherein the receiver antenna is oriented towards the RF transmitter at all locations r;
providing one or more electric current densities;
distributing, by a distribution network, the one or more electric current densities to feed each of the one or more antennas a first current density and a second current density, wherein a first current is K_{θ}(r, t)=\tilde{K}₀ cos(ωt±Φ) and a second current is K_{Φ}(r, t)=±\tilde{K}₀ cos(θ) sin(ωt±Φ), and wherein the one or more electric current density rotate azimuthally around a surface of a contoured volume or a surface, wherein at any fixed spatial location r on the surface of the sphere, the orthogonal \hat{θ}(θ, Φ) and \hat{Φ}(Φ) components of K_{(r,t)} are π/2 radians out of phase, wherein K_{θ}(r, t) and K_{Φ}(r, t) are the electric current density on a surface of the transmit structure as a function of a position vector (r) and time (t), ω is the angular frequency of rotation, θ is a polar angle, and Φ is an azimuthal; and
radiating, by the antenna array, a cumulative power pattern proportional to 1+cosine²(θ).

19. The method of claim 17, further comprising: providing multiple current densities of different frequency.

20. The method of claim 18, further comprising: encoding, by spread spectrum encoding, a stream of data across multiple different frequencies of the one or more electric current densities.
